(19) United States
(12) Patent Application Publication
(10) Pub. No.: US 2022/0199072 A1
(43) Pub. Date: Jun. 23, 2022

(54) VOICE WAKE-UP DEVICE AND METHOD OF CONTROLLING SAME

(71) Applicant: Silicon Integrated Systems Corp., Hsinchu City (TW)

(72) Inventors: Kai-Ping WANG, Hsinchu City (TW); Kun-Tien TING, Hsinchu City (TW); Pin-Han LO, Hsinchu City (TW)

(73) Assignee: Silicon Integrated Systems Corp., Hsinchu City (TW)

(21) Appl. No.: 17/545,883

(22) Filed: Dec. 8, 2021

(30) Foreign Application Priority Data
Dec. 21, 2020 (TW) 109145369

(51) Int. Cl. G10L 15/08; G10L 21/0216; G10L 25/78

(52) U.S. Cl. CPC G10L 15/08; G10L 21/0216; G10L 2021/02082; G10L 2015/088; G10L 25/78

(57) ABSTRACT

A voice wake-up device includes a microphone module, an electrical connector, and a microcontroller unit. The microcontroller unit includes at least one microcontroller and a memory for storing microcontroller-executable instructions. The microcontroller-executable instructions enable the microcontroller unit to execute multiple tasks including detecting whether a sound signal is in ambient sounds received by the microphone module, and generating an input sound signal according to the sound signal; determining whether the input sound signal includes a predetermined wake-up voice; and confirming the predetermined wake-up voice is comprised in the input sound signal and outputting a wake-up instruction to wake up the electronic device entering the non-hibernation mode from the hibernation mode.

### CROSS REFERENCE TO RELATED APPLICATIONS

This application claims the priority of Taiwan Patent Application serial No. 109145369, filed Dec. 21, 2020, the disclosure of which is incorporated herein by reference in their entirety.

### BACKGROUND OF INVENTION

### 1. Field of Invention

The present disclosure relates to a voice device, and particularly to a voice wake-up device for waking up an electronic device and a control method thereof.

### 2. Related Art

With development of information technologies, the use of electronic devices, such as computers or tablets, has been an indispensable necessity in our daily lives. People rely on computers to complete tasks, which can also improve work efficiency. The way of human-computer interaction between users and the computers or other electronic devices, that is, the way of communication or control continues to evolve. General human-computer interaction methods can be achieved through mechanical devices (for example, keyboards or mice, etc.) or electrical devices (for example, touch screens or touch pads). Nowadays, human-computer interaction has been developed through the sound of the users' voice.

The human-computer interaction of voice audio is carried out through a voice device that collects and responds to human voice. Conventional voice devices (or smart speakers) can receive voice signals and perform corresponding functions on the electronic devices on an application side after signal processing. Users do not need to use mechanical devices, such as keyboards or mice, or touch screens with their fingers to control the electronic device. When controlling by a voice device, users' do not need to touch the electronic devices with their hands, therefore additional works can be performed at the same time. However, for the conventional voice devices or smart speakers, after the electronic device (such as a computer) is idle for a period of time, it enters a power saving mode or a hibernation mode, and an internal voice device (smart speaker) also enters the power saving mode or the hibernation mode. Users cannot wake up the electronic device with a specific voice in a normal way through the smart speaker, but must use a keyboard, mouse or touch screen instead. Therefore, it is imperative to solve the aforementioned problems so that the voice device can achieve the wake-up function in various operating modes.

### SUMMARY OF INVENTION

One objective of the present disclosure is to provide a voice wake-up device for waking up an electronic device that can solve the problem that conventional electronic devices cannot be woke by voice in a hibernation mode.

Another objective of the present disclosure is to provide a voice wake-up device that can reduce a power consumption of an electronic device for a wake-up function.

Another objective of the present disclosure is to provide a voice wake-up device that can be externally connected to an electronic device and include a simplified structure and a low energy consumption design.

Another objective of the present disclosure is to provide a control method of a voice wake-up device for waking up an electronic device in a hibernation mode.

To achieve the foregoing objectives, the present disclosure provides a voice wake-up device including a microphone module for receiving ambient sounds when an electronic device is in a hibernation mode; an electrical connector for electrically connecting to a connection port of the electronic device to connect the voice wake-up device to the electronic device; and a microcontroller unit coupled to the microphone module and the electrical connector and comprising at least one microcontroller and a memory for storing executable instructions of the microcontroller which enable the microcontroller unit to execute multiple tasks comprising: detecting whether a sound signal is in the ambient sounds received by the microphone module, and generating an input sound signal according to the sound signal; determining whether the input sound signal comprises a predetermined wake-up voice; and confirming the predetermined wake-up voice is comprised in the input sound signal and outputting a wake-up instruction to wake up the electronic device entering the non-hibernation mode from the hibernation mode.

Preferably, the multiple tasks performed by the microcontroller unit further comprise performing a noise canceling processing by the microcontroller unit before the task of determining the predetermined wake-up voice is comprised in the input sound signal for canceling noises of the ambient sounds received by the microphone module, and comprise performing an echo processing for canceling the echo in the ambient sounds.

Preferably, the microphone module comprises a microphone array composed of a plurality of microphones, and the microcontroller unit comprises at least one beamforming component, wherein the microphone array is configured to receive the ambient sounds from different directions, and the beamforming component generates concentrated directional input sound signals according to the ambient sounds in the different directions.

The present disclosure provides a control method of a voice wake-up device comprising a microphone module, an electrical connector, and a microcontroller unit comprising at least one microcontroller and a memory and being configured for waking up an electronic device comprising a connecting port in a hibernation mode, the control method comprises electrically connecting the electrical connector and the connecting port of the electronic device to connect the voice wake-up device to the electronic device and setting a wake-up voice; determining whether the electronic device is in a hibernation mode or in a non-hibernation mode by the microcontroller unit; receiving ambient sounds by the microphone module when the electronic device is in the hibernation mode; detecting whether a sound signal is in the ambient sounds received by the microphone module, generating an input sound signal according to the sound signal, and judging whether the wake-up voice predetermined is comprised in the input sound signal; and confirming the wake-up voice predetermined is comprised in the input sound signal and outputting a wake-up instruction to wake up the electronic device entering the non-hibernation mode from the hibernation mode.

The voice wake-up device of the present disclosure utilizes a system-on-chip architecture to connect to a host system of the electronic device through an external connection. Not only is the control method simple, but it can also solve the problem that conventional electronic devices cannot be woke up by voice in the hibernation mode. Secondly, for sounds received by the microphone module, the voice wake-up device of the present disclosure uses the microcontroller unit to perform audio processing, which greatly reduces hardware requirements, effectively lowering manufacturing costs, and reduces energy consumption. In addition, the voice wake-up device of the present disclosure greatly reduces the power requirements of the electronic device for the voice wake-up function through the setting of a separate power supply module and its own low-energy working mode, thereby achieving effects of power saving and energy saving. Furthermore, the present disclosure effectively optimizes the human voice signal by using the microcontroller unit to perform audio processing, noise canceling processing, and echo processing, which improves a missing judging problem of a conventional voice wake-up device.

### BRIEF DESCRIPTION OF DRAWINGS

FIG. 1 is a structural block diagram of a voice wake-up device of the present disclosure.

FIG. 2 is a flowchart of a control method of the voice wake-up device of the present disclosure.

FIG. 3 is a functional block diagram of the voice wake-up device of the present disclosure.

FIG. 4 is a flowchart of the voice wake-up device while processing sound signals of the present disclosure.

FIG. 5 is a schematic status diagram of the voice wake-up device of the present disclosure.

### DESCRIPTION OF PREFERRED EMBODIMENTS

In order to make the objectives, technical solutions, and effects of the present disclosure clearer, the present disclosure will be further described in detail below with reference to the drawings and embodiments. It should be understood that the specific embodiments described herein are only used to explain the present disclosure, and the word “embodiment” used in the specification of the present disclosure means serving as an example, example, or illustration, and is not intended to limit the present disclosure. In addition, the article “a” used in the scope of the present disclosure and the appended application can generally be interpreted as meaning “one or more”, unless otherwise specified or the singular form can be clearly determined from the context. In addition, in the accompanying drawings, elements with similar or identical structures and functions are denoted by the same element numbers.

The present disclosure relates to a voice device, in particular to a voice wake-up device for waking up an electronic device in a hibernation mode. According to an embodiment, the voice wake-up device of the present disclosure realizes a function of the voice wake-up device by creating an electrical connection with the electronic device through an external connection or by being built in the electronic device. The electronic device can be a notebook computer, a desktop computer, a tablet computer, or other electronic devices that can switch between a hibernation mode and an active mode (non-hibernation mode). The hibernation mode means that a host system of the electronic device enters a hibernation state.

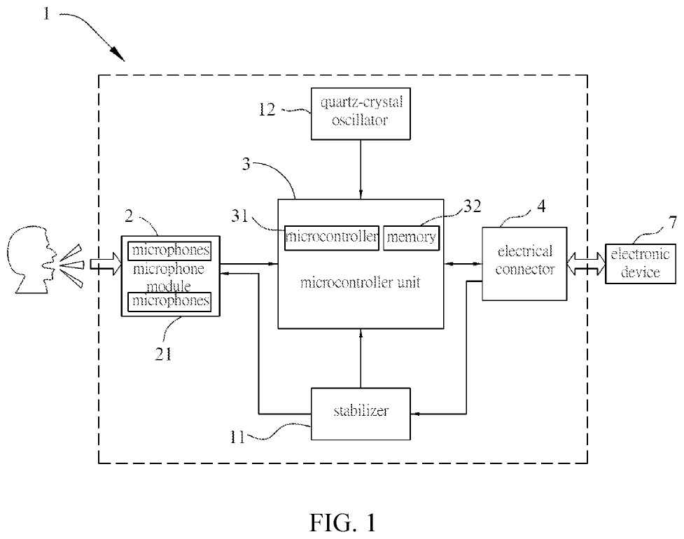

Please refer to achieving effects FIG. 1, which is a structural block diagram of a voice wake-up device of the present disclosure. The voice wake-up device 1 of the present disclosure includes a stabilizer 11, a quartz-crystal oscillator 12, a microphone module 2, a microcontroller unit 3 (MCU), and an electrical connector 4. Specifically, the voice wake-up device 1 includes a system on chip (SOC). As shown in FIG. 1, the microphone module 2 includes a microphone array composed of a plurality of microphones 21 spaced arranged, which are configured to receive ambient sounds from different directions when an electronic device 7 is in a hibernation mode. The ambient sounds may include human voice or sounds excluding human voices, that is, includes various sounds of a surrounding environment of the microphone module. In addition, according to signal processing requirements of the electronic device in an analog form or in a digital form, the microphone module 2 of the present disclosure can be further coupled to an analog-to-digital converter (not shown) for performing an analog-to-digital conversion of the ambient sounds received by the microphone module 2. Particularly, the electronic device 7 of the present disclosure is, for example, a notebook but it is not limited thereto.

The electrical connector 4 and the microphone module 2 are configured on a circuit board (not shown). The electrical connector 4 includes a plug-and-play interface, such as a universal serial bus (USB). Accordingly, the electronic device 7 further includes a port supporting the plug-and-play interface to connect to the electrical connector 4 of the voice wake-up device 1. In another embodiment, the electrical connector 4 of the present disclosure can be configured and applied to an inter-integrated circuit (I2C) inside the electronic device 7. That is, the voice wake-up device 1 of the present disclosure can be built on a circuit board inside the electronic device 7.

Referring to FIG. 1, the microcontroller unit 3 is coupled to the microphone module 2 and the electrical connector 4, and is jointly configured on the same circuit board. The microcontroller unit 3 includes a microcontroller 31 and a memory 32. The memory 32 may include an application program in a form of instructions, and the instructions are executed by the microcontroller 31 for performing tasks or actions for achieving necessary functions of the voice wake-up device 1. The memory 32 may be a type of computer storage medium, which may include volatile and non-volatile memory. That is, the memory 32 may include, but is not limited to, random access memory (RAM), read-only memory (ROM), flash memory, or other storage technologies. In addition, as shown in FIG. 1, the stabilizer 11 is coupled to the microcontroller unit 3 and the electrical connector 4 for stabilizing a voltage provided to the voice wake-up device 1. For example, an input voltage from a power supply terminal is 5V, and the stabilizer 11 is configured to adjust the input voltage to a working voltage suitable for the voice wake-up device 1, for example, 3.3V. The quartz-crystal oscillator 12 is coupled to the microcontroller unit 3 and is configured to make the microcontroller unit 3 work at a predetermined operating frequency.

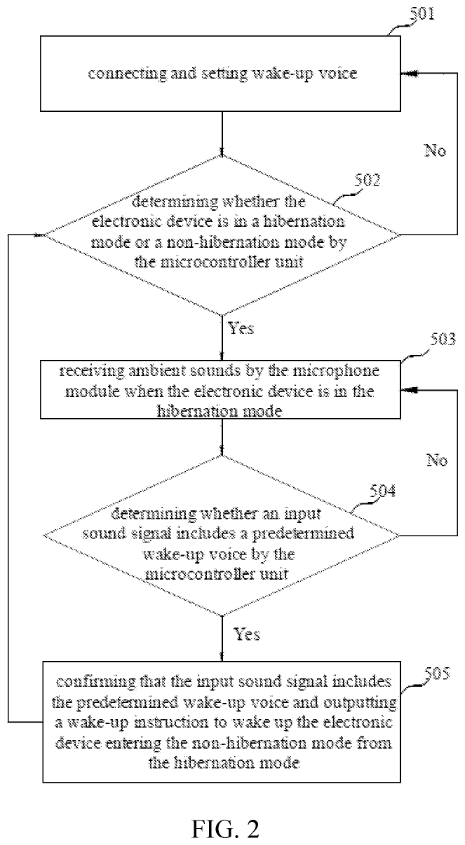

Please refer to FIG. 2, which is a flowchart of a control method of the voice wake-up device 1 of the present disclosure. The control method of the voice wake-up device of the present disclosure is configured to wake up an electronic device in a hibernation mode, and the control method includes the following actions.

Action 501: connecting and setting wake-up voice. The electrical connector of the voice wake-up device is connected to the connecting port of the electronic device, so that the voice wake-up device is electrically connected to the electronic device to set the wake-up voice. In one embodiment, a user can set the wake-up voice through a wake-up voice setting program pre-installed on the electronic device after the voice wake-up device is electrically connected to the electronic device. The wake-up voice can be a user-defined wake-up word or a tone pronounced by the user. Particularly, the voice wake-up device of the present disclosure can recognize different wake-up voices set by multiple users to perform the wake-up function.

Action 502: determining whether the electronic device is in a hibernation mode or a non-hibernation mode by the microcontroller unit. Specifically, after the voice wake-up device of the present disclosure is connected to the electronic device for the first time, since the connecting port of the electronic device (for example, a notebook computer) has the plug-and-play interface, the insertion of the voice wake-up device can be detected immediately, so that the electronic device can be set in the non-hibernation mode, i.e., an active mode. When the electronic device is idle for a period of time, it enters the hibernate mode. The hibernate mode, which is a working state other than the active mode, includes a sleep mode and a hibernation mode, and also includes a state in which the electronic device has been shut down but is still receiving power. In addition, after the voice wake-up device of the present disclosure is connected to the electronic device, the voice wake-up device will actively receive wake-up voice(s) pre-installed in the electronic device and store the wake-up voice(s) in the memory. In the state that there is no pre-installed wake-up voice, the voice wake-up device will return to action 501 and wait for the setting of the wake-up voice.

Action 503: receiving ambient sounds by the microphone module when the electronic device is in the hibernation mode. Particularly, the microphone module of the present disclosure only receives ambient sounds when the electronic device is in the hibernate mode, and automatically stops receiving the ambient sounds in the active mode.

Action 504: determining whether an input sound signal includes a predetermined wake-up voice by the microcontroller unit. Specifically, the microcontroller unit is configured to detect whether a sound signal is in the ambient sounds received by the microphone module, an input sound signal is generated according to the sound signal, and the microcontroller unit determines whether the input sound signal includes the predetermined wake-up voice. After judging that the input sound signal does not include the predetermined wake-up voice, the voice wake-up device will return to action 503.

Action 505: confirming that the input sound signal includes the predetermined wake-up voice and outputting a wake-up instruction to wake up the electronic device entering the non-hibernation mode from the hibernation mode. Particularly, once the electronic device is awakened, it means that the electronic device is in the non-hibernation mode, and the voice wake-up device of the present disclosure stops receiving ambient sounds and stops subsequent actions. That is, the voice wake-up device of the present disclosure returns to action 502 to determine whether the electronic device is in the hibernation mode or the non-hibernation mode.

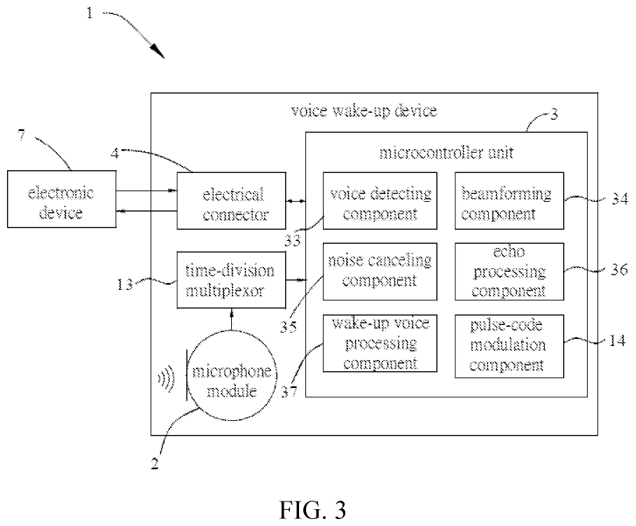

FIG. 2 has illustrated the control method of the voice wake-up device of the present disclosure. FIG. 3 is a functional block diagram of the voice wake-up device of the present disclosure to illustrate the detailed functions of the voice wake-up device. Referring to FIG. 3 in conjunction with FIG. 2 for reference, the voice wake-up device 1 of the present disclosure further includes a time-division multiplexor 13 coupled to the microphone module 2 to enable the voice wake-up device 1 to perform real-time tasks. In this embodiment, the microphone module 2 receives ambient sounds every 10 milliseconds to realize the purpose of real-time wake-up. As shown in FIG. 3, the microcontroller unit 3 further includes a voice detecting component 33, a beamforming component 34, a noise canceling component 35, an echo processing component 36, and a wake-up voice processing component 37. The voice wake-up device 1 is electrically connected to the electronic device 7 through the electrical connector 4. In addition, the microcontroller unit 3 further includes a pulse-code modulation component 14 for adjusting a pulse signal processed by the microcontroller unit 3 in accordance with the signal requirements of the electronic device 7. The aforementioned components are stored in the memory 32 in a form of an application program, and are configured to perform different tasks. The detailed description is as follows. Particularly, the beamforming component 34, the noise canceling component 35, and the echo processing component 36 of the present disclosure can be configured in the voice wake-up device of the present disclosure according to actual requirements. That is, the aforementioned components for optimizing sound signal processing can be one of them, a combination of any two or more of them, or none of them is configured. The configuration of the aforementioned components for optimizing sound signal processing will not affect the operation of the microcontroller unit 3.

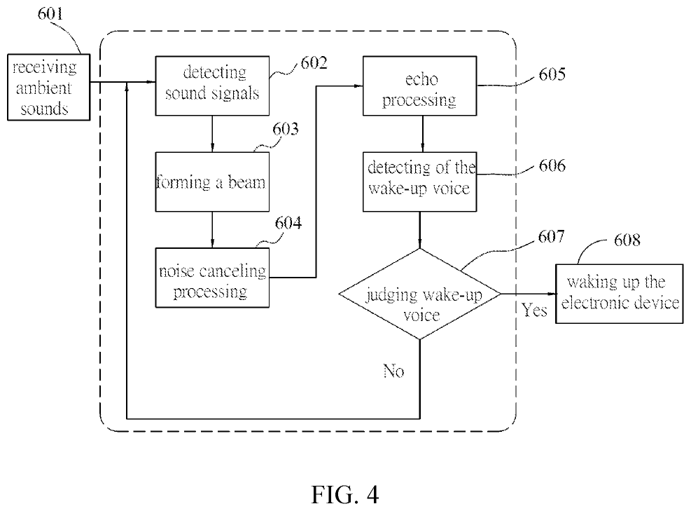

FIG. 4 is a flowchart of the voice wake-up device while processing sound signals of the present disclosure. Please refer to FIG. 4 in conjunction with FIGS. 2 and 3 for reference. Corresponding to FIG. 2 for the control method of the voice wake-up device disclosed in the present disclosure, the detailed flow of the control method includes the actions shown in FIG. 4, which includes action 601: receiving ambient sounds. Specifically, a microphone array composed of a plurality of microphones included in the microphone module 2 is configured to receive ambient sounds from different directions and different distances.

Action 602: detecting sound signals. That is, the voice detecting component 33 is configured to detect whether the ambient sounds received by the microphone module 2 has sound signals, and the input sound signal is generated according to the sound signals of the ambient sounds. Specifically, when the voice detecting component 33 does not detect the presence of a sound signal in the ambient sounds, the work energy consumption of the voice detecting component 33 is extremely low. Because it does not detect the presence of a sound signal in the ambient sounds, it has not yet entered the execution of subsequent actions so that the energy consumption of the voice wake-up device 1 can be further reduced.

Action 603: forming a beam. The beamforming component 34 is configured to generate concentrated input sound signals in different directions. Specifically, the beamforming component 34 is configured for responding to the spatial separation formed by the microphone array, and generating concentrated directional input sound signals according to the ambient sounds from different directions and different distances, so as to distinguish signals of different sound sources more clearly.

Action 604: noise canceling processing. The noise canceling component 35 is configured to perform a noise canceling processing for reducing the noise of the ambient sounds received by the microphone module 2. For example, noise in the environment or traffic noise can be eliminated by the noise canceling component 35.

Action 605: echo processing. That is, the echo processing component 36 is configured to perform an echo processing to cancel the echo contained in the ambient sounds.

Action 606: detecting of the wake-up voice. The wake-up voice processing component 37 is configured to detect whether the input sound signal includes the wake-up voice. That is, it detects whether the input sound signal has human voice, so as to avoid the wake-up voice judgment for all sounds, which affects the efficiency of voice judgment.

Action 607: judging wake-up voice. The wake-up voice processing component 37 is configured to determine whether the input sound signal includes a predetermined wake-up voice. That is, whether the user-defined wake-up word or the tone pronounced by the user is included is judged according to the input sound signal with human voice. It is determined based on the input sound signal that the predetermined wake-up voice is not included, and then it returns to action 602.

Action 608: waking up the electronic device. That is, it is confirmed that the input sound signal includes the predetermined wake-up voice, and the wake-up instruction is output to wake up the electronic device entering the non-hibernation mode from the hibernation mode.

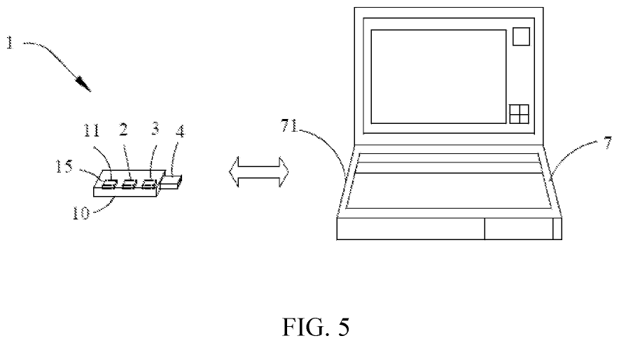

FIG. 5 is a usage status schematic diagram of the voice wake-up device of the present disclosure. As shown in FIG. 5, the voice wake-up device 1 of the present disclosure is a portable device with a plug-and-play interface. In specific implementation, the voice wake-up device 1 of the present disclosure further includes a case 10 with an accommodating space in the case 10 for accommodating the microphone module 2, the microcontroller unit 3, and the electrical connector 4. The electrical connector 4 has a USB connector for connecting to the connecting port 71 of the electronic device 7 with a corresponding interface so that the voice wake-up device 1 can be plugged and electrically connected to the electronic device 7.

Referring to FIG. 5, particularly, the voice wake-up device 1 of the present disclosure further includes a power supply module 15 coupled to the stabilizer 11. The power supply module 15 serves as a power supply source of the voice wake-up device 1 independent to the electronic device 71. In one embodiment, the power supply module 15 may be equipped with a battery (not shown) to provide the power required by the voice wake-up device 1. In another embodiment, the power supply module 15 can be additionally connected to a cable to provide power through the transmission of an external power source. For example, the power supply module 15 may have a port having a micro USB interface (not shown), which is connected to the external power source through the cable for power transmission. With the configuration of the power supply module 15, the voice wake-up device 1 of the present disclosure has a separate power supply and does not consume the power of the electronic device 7. In addition, as mentioned above, the voice wake-up device 1 of the present disclosure can also be built into a host system of the electronic device, for example, the voice wake-up device 1 can be connected to the host system through an I2C architecture. Since the energy consumption of the voice wake-up device 1 of the present disclosure is extremely low, which meets the requirements of environmental protection and energy saving standards in the mainstream market. Therefore, it will not cause excessive energy consumption of electronic devices even built in the electronic device.

In summary, the disclosed voice wake-up device utilizes a system-on-chip architecture to connect to the host system of the electronic device through an external connection. Not only is the control method simple, but it can also solve the problem that conventional electronic devices cannot be awakened by voice in the hibernation mode. Secondly, for sounds received by the microphone module, the voice wake-up device of the present disclosure uses the microcontroller unit to perform audio processing, which greatly reduces the hardware requirements, effectively lowers the manufacturing cost, and further reduces the energy loss. In addition, the voice wake-up device of the present disclosure greatly reduces the power requirements of the electronic device for the voice wake-up function through the setting of a separate power supply module and its own low-energy working mode, and achieves the effects of power saving and energy saving. Furthermore, the present disclosure effectively optimizes the human voice signal by using the microcontroller unit to perform audio processing, noise canceling processing, and echo processing, which improves the missing judging problem of a conventional voice wake-up device.

The above-described embodiments can be implemented as a data signal processor, an analog processor, etc. by using a programming method (such as using a computer or a processor). However, in other embodiments, professional or dedicated circuits (including analog circuits and/or digital logic circuits) may be configured to implement one or more of the elements, functions, or elements. The term ‘component’ or ‘element’ as used herein is intended to include any hardware, software, logic, or combination of the foregoing for implementing the functions attributed to the component or element.

The above-mentioned embodiments are used to illustrate the technical ideas of the present disclosure, but are not used to limit the technical ideas of the present disclosure. Therefore, the scope of rights of the present disclosure is not limited to this embodiment. The scope of protection of this disclosure should be interpreted by the claims, and it should be interpreted that all technical ideas that are the same or equivalent to the above-mentioned protection scope are included in the scope of rights of this disclosure.

Accordingly, although the present invention has been disclosed as a preferred embodiment, it is not intended to limit the present invention. Those skilled in the art without departing from the scope of the present invention may make various changes or modifications, and thus the scope of the present invention should be after the appended claims and their equivalents.

What is claimed is:

1. A voice wake-up device, comprising:
a microphone module for receiving ambient sounds when an electronic device is in a hibernation mode;
an electrical connector for electrically connecting to a connection port of the electronic device to connect the voice wake-up device to the electronic device; and
a microcontroller unit coupled to the microphone module and the electrical connector and comprising at least one microcontroller and a memory for storing executable instructions of the microcontroller which enable the microcontroller unit to execute multiple tasks comprising:
detecting whether a sound signal is in the ambient sounds received by the microphone module, and generating an input sound signal according to the sound signal;
determining whether the input sound signal comprises a predetermined wake-up voice; and
confirming the predetermined wake-up voice is comprised in the input sound signal and outputting a wake-up instruction to wake up the electronic device entering the non-hibernation mode from the hibernation mode.

2. The voice wake-up device of claim 1, wherein the multiple tasks performed by the microcontroller unit further comprise performing a noise canceling processing by the microcontroller unit before the task of determining the predetermined wake-up voice is comprised in the input sound signal for canceling noises of the ambient sounds received by the microphone module, and comprise performing an echo processing for canceling the echo in the ambient sounds.

3. The voice wake-up device of claim 1, wherein the microphone module comprises a microphone array composed of a plurality of microphones, and the microcontroller unit comprises at least one beamforming component, wherein the microphone array is configured to receive the ambient sounds from different directions, and the beamforming component generates concentrated directional input sound signals according to the ambient sounds in the different directions

4. The voice wake-up device of claim 1, further comprising a stabilizer and a quartz-crystal oscillator respectively coupled to the microcontroller unit.

5. The voice wake-up device of claim 4, further comprising a power supply module coupled to the stabilizer and serving as a power supply source for the voice wake-up device independent to the electronic equipment.

6. A control method of a voice wake-up device for waking up an electronic device in a hibernation mode, the electronic device having a connecting port, the voice wake-up device comprising a microphone module, an electrical connector, and a microcontroller unit comprising at least one microcontroller and a memory, and the control method comprising:
electrically connecting the electrical connector and the connecting port of the electronic device to connect the voice wake-up device to the electronic device and setting a wake-up voice;
determining whether the electronic device is in a hibernation mode or in a non-hibernation mode by the microcontroller unit;
receiving ambient sounds by the microphone module when the electronic device is in the hibernation mode;
detecting whether a sound signal is in the ambient sounds received by the microphone module, generating an input sound signal according to the sound signal, and judging whether the wake-up voice predetermined is comprised in the input sound signal; and
confirming the wake-up voice predetermined is comprised in the input sound signal and outputting a wake-up instruction to wake up the electronic device entering the non-hibernation mode from the hibernation mode.

7. The control method of the voice wake-up device of claim 6, further comprising performing a noise canceling processing by the microcontroller unit before determining the wake-up voice predetermined is comprised in the input sound signal for canceling noises of the ambient sounds received by the microphone module, and comprising performing an echo processing for canceling echoes in the ambient sounds.

8. The control method of the voice wake-up device according to claim 6, wherein receiving the ambient sounds by the microphone module when the electronic device is in the hibernation mode comprises: receiving the ambient sounds from different directions by a microphone array composed of a plurality of microphones of the microphone module, and generating concentrated directional input sound signals according to the ambient sounds in the different directions by at least one beamforming component of the microcontroller unit.

9. The control method of a voice wake-up device of claim 6, wherein the voice wake-up device further comprises a stabilizer coupled to the microcontroller unit, a quartz-crystal oscillator coupled to the microcontroller unit , and a power supply module coupled to the stabilizer, the power supply module is configured as a power supply source for the voice wake-up device independent to the electronic device, the stabilizer is configured to stabilize the voltage supplied to the voice wake-up device, and the quartz-crystal oscillator is configured to make the microcontroller unit operate at a predetermined operating frequency.

10. The control method of the voice wake-up device of claim 6, wherein the microphone module repeatedly executes an action of receiving the ambient sounds after a specified interval time has elapsed to make the voice wake-up device be able to wake up the electronic device instantly.
